(19) United States
(12) Patent Application Publication
(10) Pub. No.: US 2018/0362301 A1
(43) Pub. Date: Dec. 20, 2018

(54) SUSPENSION MOTION-RESISTING DYNAMIC SYSTEM AND SUSPENSION ACTIVE DYNAMIC CARRIER MODULE

(71) Applicant: CHEN-HSIN LIN, NEW TAIPEI CITY (TW)

(72) Inventor: CHEN-HSIN LIN, NEW TAIPEI CITY (TW)

(21) Appl. No.: 16/003,309

(22) Filed: Jun. 8, 2018

(30) Foreign Application Priority Data
Jun. 14, 2017 (TW) 106208572

(51) Int. Cl. B66B 9/00; B66B 7/02; B61B 7/06

(52) U.S. Cl. CPC B66B 9/00; B66B 9/06; B61B 7/06; B66B 7/026

(57) ABSTRACT

A suspension motion-resisting dynamic system includes two support devices and a hoisting drive module that includes a suspension device, a motion-resisting device, and a drive device. The suspension device has two terminal ends and is fixed and stretched by the support devices. The motion-resisting device is set in contact with the suspension device. The drive device is coupled to the motion-resisting device for driving the motion-resisting device to cause the motion-resisting device to move along the suspension device. A suspension active dynamic carrier module includes a suspension carrier drive module, which includes a suspension device, a carrier device, and a drive device. The suspension device is connected to the support device. The drive device is arranged on the carrier device and is connected to the suspension device to generate power that causes the carrier device to move along the suspension device.

### FIELD OF THE INVENTION

The present invention relates to a dynamic carrier system and module, and more particular to a suspension motion-resisting dynamic system and a suspension active dynamic carrier module.

### BACKGROUND OF THE INVENTION

Elevators are one of the commonly used devices for modern people. The known designs of elevator have drawbacks. Specifically, the elevators that are currently used are designed to use counterweights for balancing the weight of the elevator. The counterweights are generally of a bulky size and a high cost and often occupy an extra useful space.

Further, the known designs of elevators require a large number of parts that are generally quite diversified for field installation of an elevator in a work site. This makes the assembly and mounting difficult and the labor-consuming and complicated process of assembly and the management of a number of diversified elevator parts cause an increase of cost, time, and difficulty for field installation of an elevator.

On the other hand, cable cars are also a common and widely used transportation and are often built on tops of mountains. However, the distance between the tops of mountains is often extremely large so that cables that support a cable car often get slackening down. Additional intermediate support towers must be built between the mountains to support the movement of the cable car. Building a large number of supporting towers is time-consuming and labor-consuming, and is also costly and hard to maintain, and need to occupy a large amount of space.

A large population of people are living in high buildings or working in high office buildings today. Natural catastrophes, such as earthquakes and fires, or human terror attacks often cause severe disaster that force the large number of people to instantaneously move from the high building down to the surface.

Further, pedestrian overpasses or footbridges are important walkways for people to walk across heavy traffic roads. However, building a pedestrian overpass or a footbridge is not an easy construction operation. In certain examples, people are not willing to use the pedestrian overpass or footbridge and this lowers down the value of the pedestrian overpass or footbridge.

In many countries or areas, high speed ways are often constructed on the surface and once a high speed way that takes the form of an extended strip on the surface and would block communication between the two sides of the way.

Thus, it is urgently desired to have a novel carrier device that overcomes such drawbacks and shortcomings.

### SUMMARY OF THE INVENTION

In view of the above problems, the present invention provides a suspension active dynamic carrier module. The suspension active dynamic carrier module comprises at least one suspension carrier drive module. The at least one suspension carrier drive module comprises at least one carrier device, at least one suspension device, and at least one drive device. The at least one suspension device is connected to at least one support device. The at least one drive device is arranged on the at least one carrier device and is connected to the at least one suspension device to generate power for causing the at least one carrier device to move along the at least one suspension device.

In addition, the present invention provides a suspension motion-resisting dynamic system. The suspension motion-resisting dynamic system comprises at least two support devices and at least one hoisting drive module. The at least one hoisting drive module comprises at least one suspension device, at least one drive device, and at least one motion-resisting device. The at least one suspension device has two terminal ends and is fixed and stretched by the at least two support device. The at least one motion-resisting device is set in contact with the at least one suspension device. The at least one drive device is coupled to the at least one motion-resisting device and the at least one carrier device for driving the at least one motion-resisting device to cause the at least one motion-resisting device to move along the at least one suspension device.

In the above description, the present invention provides a suspension motion-resisting dynamic system and a suspension active dynamic carrier module, and assembly processes of the two, which allow for completion of installation in a fast, save, and stable fashion in a manner of saving time, saving effort, saving manufacturing cost, saving installation step, and saving space occupied to suit for various needs of users and can be used in various applications, including escape, cable car, elevation, recreation, and carrying.

### BRIEF DESCRIPTION OF THE DRAWINGS

FIG. 1 is a schematic view illustrating a suspension active dynamic carrier module according to the present invention;

FIG. 2 is a schematic view illustrating the suspension active dynamic carrier module according to the present invention, including a rail module;

FIG. 3 is a schematic view illustrating, in an enlarged form, a connection member of FIG. 2;

FIGS. 4A and 4B are respectively a perspective view and a side elevational view illustrating a suspension motion-resisting dynamic system according to the present invention;

FIGS. 4C and 4D are schematic views each illustrating an example of a support device of the suspension motion-resisting dynamic system according to the present invention;

FIG. 5 is a schematic view illustrating another example of the suspension motion-resisting dynamic system according to the present invention;

FIG. 6 is a schematic view illustrating an example of application of the suspension motion-resisting dynamic system according to the present invention to a cable car;

FIG. 7 is a schematic view illustrating an example of application of the suspension motion-resisting dynamic system according to the present invention to mountain climbing facilities;

FIGS. 8A and 8B are respectively a bottom view and a side elevational view illustrating an application of the suspension motion-resisting dynamic system according to the present invention to overpass facilities.

### DETAILED DESCRIPTION OF THE PREFERRED EMBODIMENTS

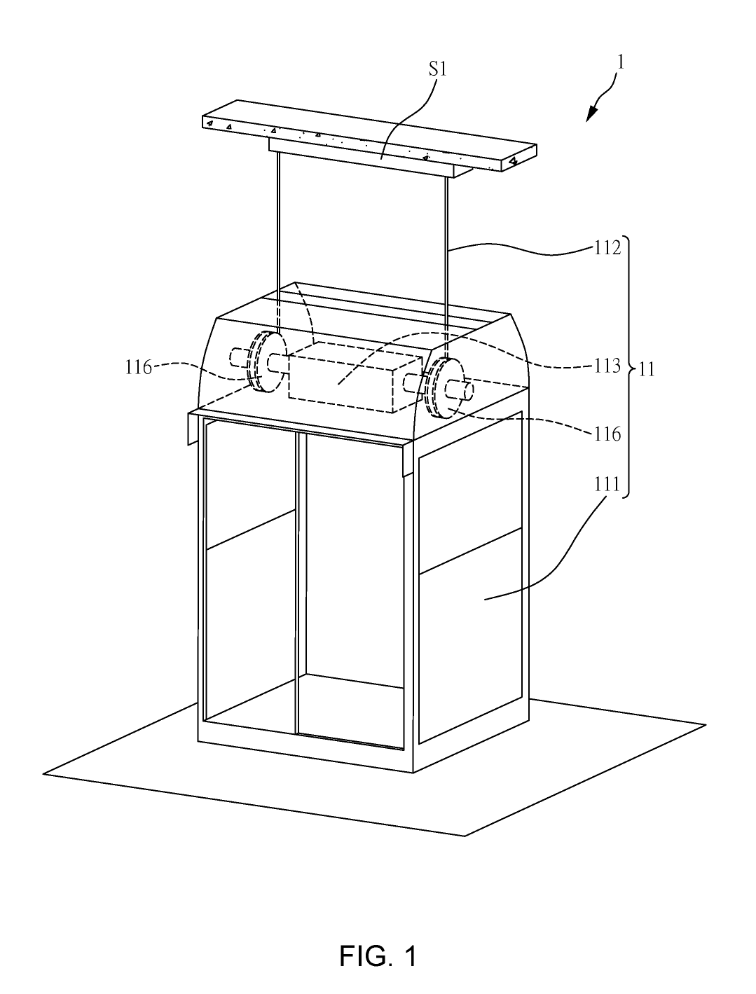

Referring to FIG. 1, which is a schematic view illustrating a suspension active dynamic carrier module according to the present invention, the suspension active dynamic carrier module 1 comprises at least one suspension carrier drive module 11. The at least one suspension carrier drive module comprises at least one carrier device 111, at least one suspension device 112, and at least one drive device 113. The at least one suspension device 112 is connected to at least one support device S1. The at least one drive device 113 is arranged on the at least one carrier device 111 and is connected to the at least one suspension device 112 to generate power that drives the at least one carrier device 111 to move along the at least one suspension device 112.

In the above description, the term “active dynamic” as used in this invention refers to arranging the drive device 113 that generates power on the carrier device 111 and, at the time when power is generated to drive the carrier device 111 to move, moving with the carrier device 111. The term “module” refers to the at least one carrier device 111, the at least one suspension device 112, and the at least one drive device 113 being arranged together as a unitary structure and an assembling process being carried out by attaching, in a suspending manner, the at least one suspension device 112 to the at least one support device S1. It is noted that the term of “being arranged together as a unitary structure” includes carrying out a procedure through any element, structure, means, process, and manufacture for connecting, coupling, and enclosing to have multiple parts that are separate combined together as a single unitary element.

In the embodiments of the present invention, the at least one support device S1 is arranged on at least one support frame, a ceiling, and/or a fixture plane to support or suspend the at least one carrier device 111 and the at least one drive device 113. In the embodiments of the present invention, the support device S1 is not limited to any configuration and any element, structure, means, and structure that is capable of supporting or suspending can be used as the support device of the present invention.

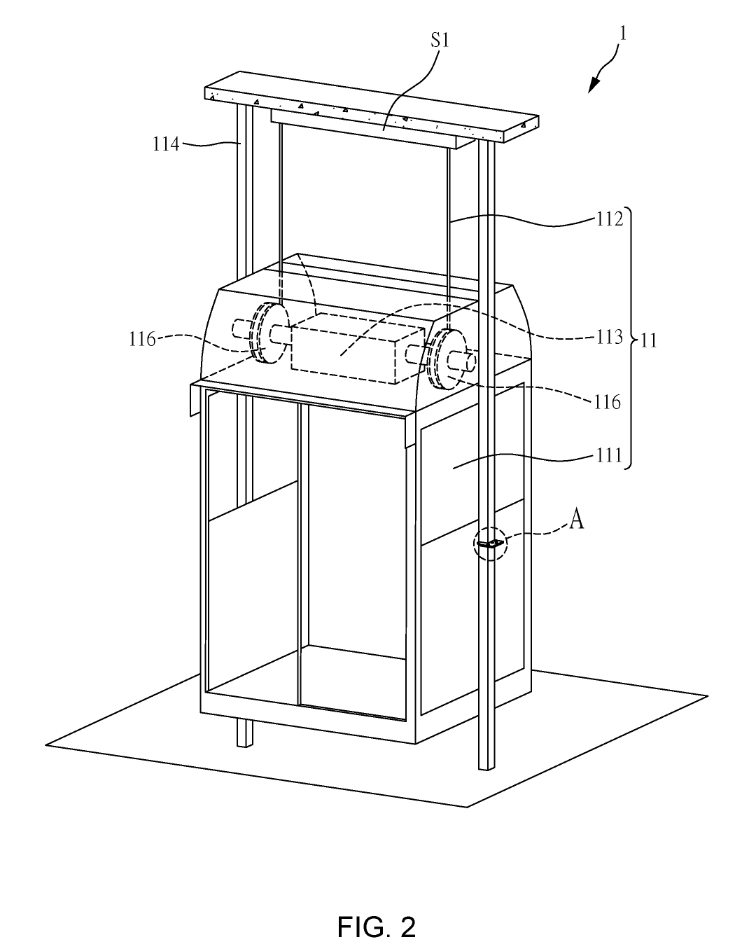

Referring to FIG. 2, a schematic view is provided to illustrate the suspension active dynamic carrier module 1 according to the present invention, including rail module. In the above description, the suspension active dynamic carrier module 1 of the present invention is structured such that the drive device 113 is arranged on the carrier device 111 to conveniently drive the suspension device 112 to elevate or lower down the carrier device 111. In an actual operation of elevating and lowering, to eliminate wobbling of the carrier device 111, the suspension active dynamic carrier module 1 further comprises at least one rail module 114, which is arranged to correspond, in position, to the at least one carrier device 111 so that the at least one carrier device 111 may be elevated or lowered down through the at least one rail module 114.

The at least one rail module 114 may comprise a foldable rail module, an extendible rail module, a cascade rail module, or a curved rail module, and variation and combination of different configurations of designs can be made as desired and this invention imposes no specific limitation. For example, when a user needs to avoid, in an elevating or lowering process, collision with an obstacle in a building space, such as a ceiling, a combination of the cascade rail module and the curved rail module can be selected so that a cascade arrangement may be taken to connect, in cascade, with a curved rail in order to involve a curved rail that helps avoid the obstacle in the building space. Or, alternatively, a single curved rail module may be used to provide a curve that involves a specifically designed angle to handle an obstacle in the building space. This invention imposes no specific limitation to the configuration or arrangement thereof.

The various configurations of the rail module 114, as described above, may comprise at least one rail base (not shown) for securely mounting the rail module 114 on a fixture plane.

The at least one rail module 114 comprises at least N rails, which are arranged on a plane so that the carrier device 111 is allowed to elevate and lower down on the at least one rail module 114, where N is a positive integer greater than 1. The number, lengths, widths, and configurations of actually used rails are determined according to the user's requirement or the space design of a building.

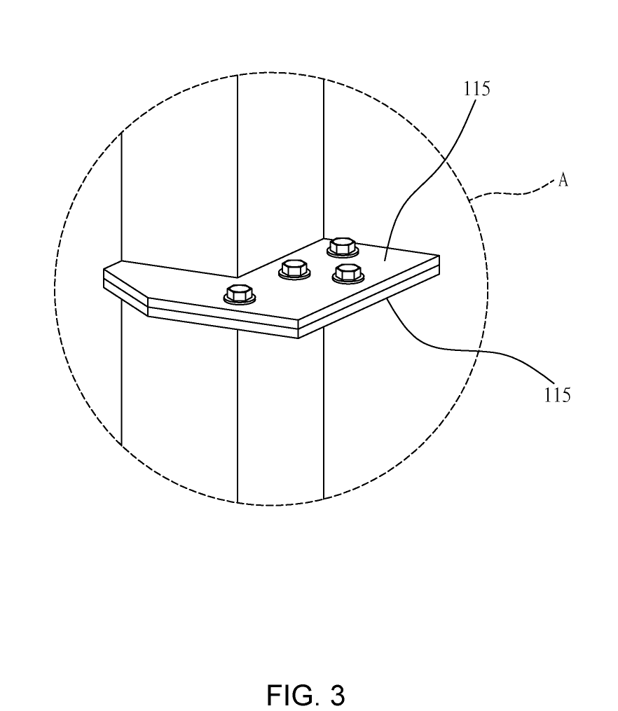

Referring to FIG. 3, a schematic view is provided to show a connection member of FIG. 2 in an enlarged form. The at least N rails of the cascade rail module each have two ends each of which comprises at least one connection member 115 for coupling with or connection with each other. In the embodiments of the present invention, the connection member 115 is not limited to any configuration and any element, structure, means, method, and manufacturing process that is effective for connection can be used in the connection member 115 of the present invention.

The suspension active dynamic carrier module 1 further comprises at least one hoisting device (not shown) for hoisting the at least N rails for connection with each other through at least one connection member 115 and arrangement on a fixture surface. Specifically, taking the cascade rail module as an example, to connect three (3) rails in cascade, the hoisting device hoists the first rail to allow the first rail to be securely fixed on a fixture surface. Next, the hoisting device hoists the second rail and the connection member 115 is used to connect the second rail to the first rail. Finally, the hoisting device hoists the third rail, and the connection member 115 is used to connect the third rail to the second rail. Further, although a hoisting device is used to hoist the at least N rails in some embodiments of the present invention, this invention is not limited thereto and any machine or device that could carry, lift and lower, and hoist is considered in the scope of the present invention. Examples include, robotic arms, robots, and hydraulic machines.

The suspension active dynamic carrier module 1 further comprises a correction device (not shown), which is used, after the connection of the at least N rails, to correct the position or positional relationship of the at least N rails. Similarly, the embodiments of the present invention do not impose any specific limitation to the correction device and any element, structure, means, and structure that is operable for correction, positioning, and detection can be used as the correction device of the present invention.

Further, to enhance stability and strength of the rails, the suspension active dynamic carrier module 1 further comprises at least N fixing members (not shown), which are respectively connected to the at least N rails. Fixing can be made by using various coupling elements to directly couple to the at least N rails in order to strengthen and fix the at least N rails. In the embodiments of the present invention, the fixing members is not limited to any configuration and any element, structure, means, method, and manufacturing process that is effective in fixing and coupling can be used as the fixing member of the present invention.

The suspension active dynamic carrier module 1 of the present invention further comprises an assembly process, which comprises a step of installing at least one suspension carrier drive module 11. The step of installing at least one suspension carrier drive module 11 comprises installing at least one carrier device 111; installing at least one suspension device 112 to connect the at least one carrier device 111 to at least one support device S1 for suspending the at least one carrier device 111; and installing at least one drive device 113 on the at least one carrier device 111 to drive the at least one suspension device 112 to elevate and lower down the at least one carrier device 111.

In the above description, in the step of installing at least one suspension carrier drive module 11, the various sub-steps involved are provided for illustration and explanation and in fact, before the installation of the present invention, all the devices (including the at least one carrier device 111, the at least one suspension device 112, and the at least one drive device 113) have already been combined together and arranged in the suspension carrier drive module 11 to provide a unitary structure. Thus, in the installation, it only needs to have the at least one suspension device 112 attached to and suspended from the at least one support device S1 to complete the step of installation. In other words, it only needs to transport the suspension carrier drive module 11 of the present invention to the site of installation and attach and suspend the at least one suspension device 112 on the at least one support device S1 to complete the installation operation, while the remaining components, including the rail module 114, could be optionally installed, as desired by a user.

Further, in the assembly process of the suspension active dynamic carrier module 1, the rail module 114, the support devices S1, S2, the fixing members, the connection member 115, the hoisting device, and the correction device involved are similar in structure and operation to those involved in the above description regarding the suspension active dynamic carrier module 1 and repeated description will be omitted.

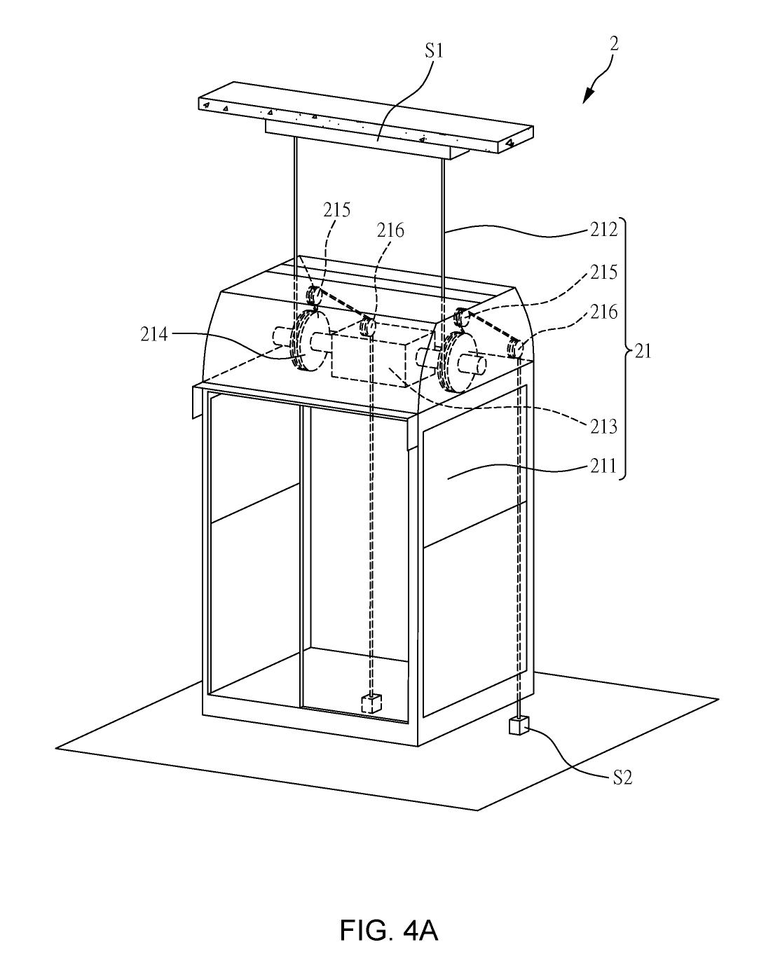

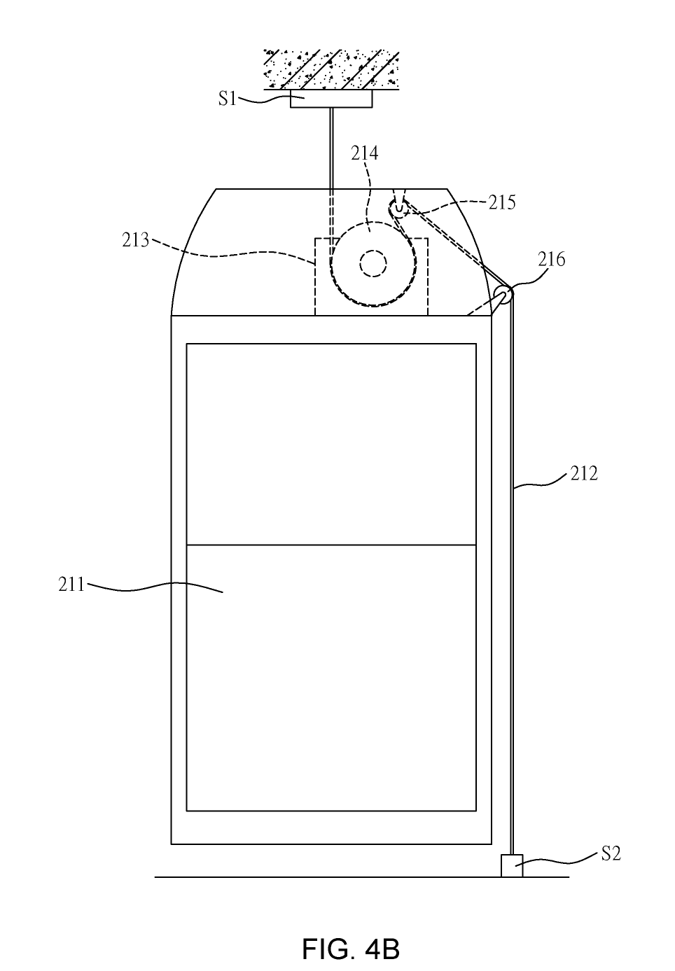

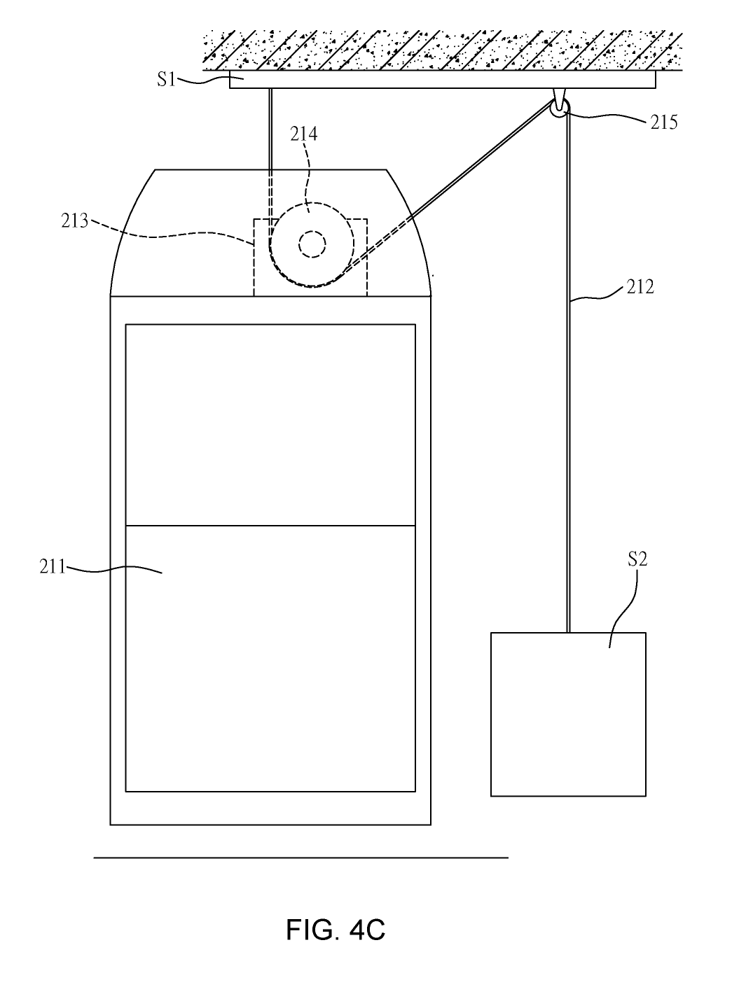

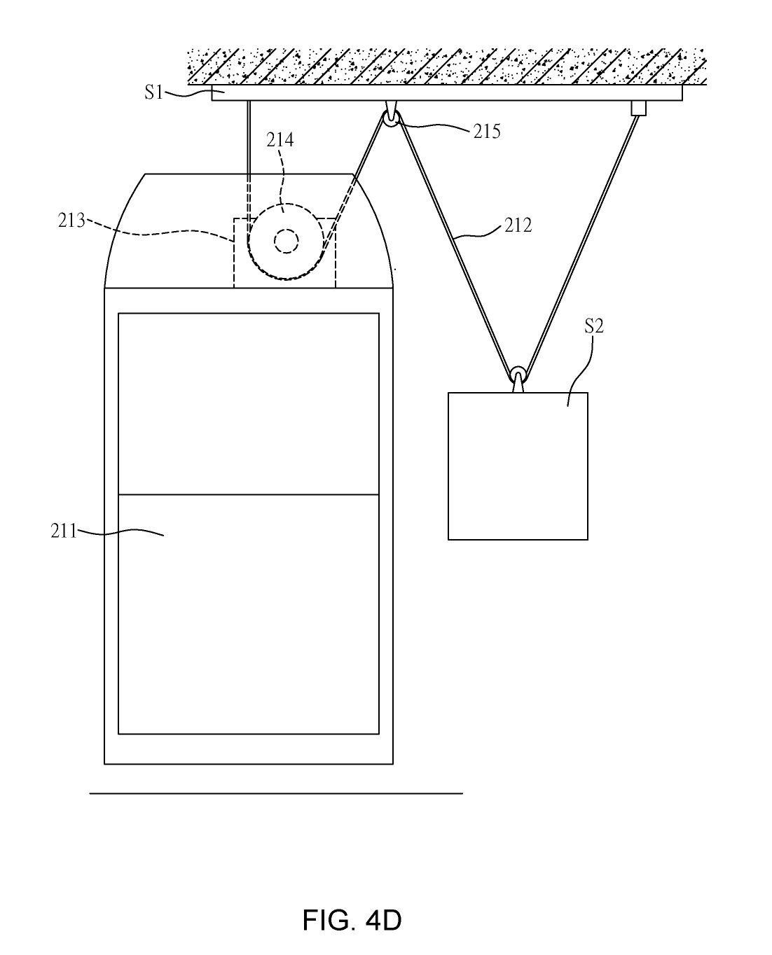

Referring to FIGS. 4A and 4B, which are respectively a perspective view and a side elevational view illustrating a suspension motion-resisting dynamic system according to the present invention, the suspension motion-resisting dynamic system 2 comprises at least two support devices S1, S2 and at least one hoisting drive module 21. The at least one hoisting drive module 21 comprises at least one suspension device 212, at least one drive device 213, and at least one motion-resisting device 214. The at least one suspension device 212 has two terminal ends and is stretched and fixed by means of the at least two support device S1, S2. The at least one motion-resisting device 214 is set in contact with the at least one suspension device 212. The at least one drive device 213 is coupled to the at least one motion-resisting device 214 for driving the at least one motion-resisting device 214 to have the at least one motion-resisting device 214 moving along the at least one suspension device 212.

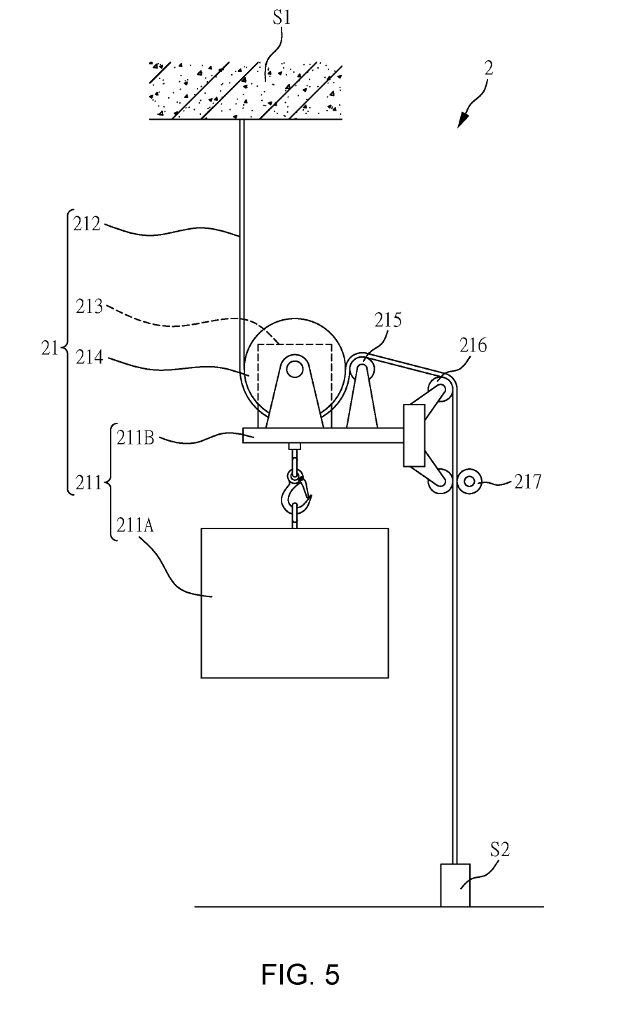

Referring to FIG. 5, a schematic view is provided to illustrate another example of the suspension motion-resisting dynamic system 2 according to the present invention. The hoisting drive module 21 of the suspension motion-resisting dynamic system 2 further comprises at least one carrier device 211. The carrier device 211 comprises a cabin 211A and a rack 211B. The rack 211B is arranged separate from the cabin 211A (see the example of FIG. 5) or is alternatively combined with the cabin 211A as a unitary structure (see the example of FIGS. 4A and 4B). No specific limitation is given in this invention. Further, for the arrangement that the rack 211B and the cabin 211A are separate, the rack 211B is arranged to suspend the cabin 211A. Further, the structure that the rack 211B may take to suspend the cabin 211A may comprise any element, structure, means, and structure that is effective in connecting and coupling. As such, as an illustrative example, the cabin 211B may be replaced with a load-carrying or transporting device, such as a ship and an automobile, and it only needs to provide, on a main body thereof, with a part or a structure that can be coupled with, connected to, suspended from, or combined with the rack 211B, wherein based on an arrangement that the support devices S1, S2 are installed in different environments or different applications, the main body may be moved between two points respectively defined by the support devices 81, S2.

Similarly, in the instant embodiment, the term “module” is defined as that set up in the above description concerning the suspension active dynamic carrier module 1 and repeated description will be omitted herein. A difference between the instant embodiment and the previous embodiment is that in the previous embodiment, the suspension active dynamic carrier module 1 uses the at least one drive device 113 to drive the spool disk 116 to wind/unwind the at least one suspension device 112 for elevating and lowering down the carrier device 111, and oppositely, the instant embodiment uses the at least one drive device 113 to drive the at least one motion-resisting device 214 to cause the at least one motion-resisting device 214 to scramble and advance along the at least one suspension device 212, meaning through an increase of a frictional force (that resists or prevents skidding) between the at least one motion-resisting device 214 and the at least one suspension device 212, the at least one motion-resisting device 214 is capable of climbing along the at least one suspension device 212 and to move efficiently according to the environment, the configuration, or the position of the arrangement of the support devices S1, S2. In an example that the hoisting drive module 21 comprises the at least one carrier device 211, the at least one motion-resisting device 214 may also drive the at least one carrier device 211 to move together.

Further, in addition to the arrangement of the motion-resisting device 214, the suspension motion-resisting dynamic system 2 may further include, according to additional factors, including the environment and position of arrangement, an arrangement of at least one motion-resisting member, at least one supporting member, at least one stabilizing member, and at least one subordinate dynamic device, of which details are provided below.

The suspension device 212 may comprises structure including a wire, a steel cable, a steel chain, a toothed rack, a chain, or a belt. In the embodiments of the present invention, the suspension device 212 is not limited to any specific configuration and any element, structure, means, and structure that is effective in suspending and hanging can be used as the suspension device 212 of the present invention.

The support device S1, S2 is mounted on at least one ground surface, under at least one ground surface, on at least one building, on at least one supporting post, or on at least one mountain top, or is connected, in a dynamic manner, to the suspension device 212 to increase the tension of the suspension device. The support device S1, S2 comprises a structure including a windlass, a winch, and a weight block. In the embodiments of the present invention, the support device S1, S2 is not limited to any specific configuration and element, structure, means, and structure that is effective in fixing the suspension device 212 and increasing the tension of the suspension device 212 can be used as the support device S1, S2 of the present invention. As shown in FIGS. 4C and 4D, which are schematic views each illustrating an example of the support device of the suspension motion-resisting dynamic system according to the present invention, the support device S2 comprises at least one weight block, which is combined with at least one motion-resisting member 215 (of which description will be provided below) for connecting, in a dynamic manner, to the suspension device 212, meaning the support device S2 being movable with the suspension device 212 in order to increase the tension of the suspension device 212 to further increase the frictional force between the motion-resisting device 214 and the suspension device 212 to prevent the motion-resisting device 214 from skidding. Or, in another embodiment of the present invention, the weight of the support device S2 can be dynamically increased according to the frictional force between the motion-resisting device 214 and the suspension device 212. In a further embodiment of the present invention, windlass and wire are taken as an example, where an end of the wire is fixed on the ground with nay fixing member, such as being directly buried in the ground with concrete, while an opposite end is attached to and windable by the windlass to increase the tension of the wire. Similarly, the windlass is fixed through any measure or structure. Or alternatively, the windlass is arranged one mountain top, while an end of the wire is securely fixed to another mountain top in a manner of being not detached or released therefrom wherein the mountain top where the windlass is mounted can be used to wind up the opposite end of the wire.

The drive device 213 comprises a device that can generate kinetic energy, such as a motor and an internal combustion engine in order to supply a driving power. The at least one drive device 213 and the at least one motion-resisting device 214 are arranged on the at least one carrier device 211. Taking the previously described carrier device 211 as an example, the drive device 213 and the motion-resisting device 214 are connected to and fixed to the rack 211B of the carrier device 211. In addition, the drive device 213 is additionally provided with a housing. The style, opening, position and the relationship of the housing with respect to the suspension device and the motion-resisting device are no novel part of the present invention and are not specifically limited and disclosed herein.

The motion-resisting device 214 is connected to the drive device 213 and is driven by the drive device 213 to move. The position, number, and configuration of the arrangement of the motion-resisting device 214 can be varied according to practical requirement. For example, in other embodiment of the present invention, the motion-resisting device 214 is arranged at a position on two sides, top, bottom of the carrier device 211 and the present invention does not provide any limitation to the position of arrangement thereof. The motion-resisting device 214 is so operated that by means of the frictional force between the motion-resisting device 214 and the suspension device 212, when the drive device 213 drives the motion-resisting device 214, the motion-resisting device 214 (together with the carrier device 211, if the carrier device 211 is included) to move along the suspension device 212. Direction, position, distance, angle, height, and stability of the movement are determined according to the position, number, and configuration of the arrangement of the motion-resisting device 211 and the support device S1, S2.

Following the above description, taking the above described the suspension device 212 of wire as an example, when the two ends of the wire are stretched and fixed by the support devices S1, S2, the tension force of the wire is increased and the frictional resistance force between the wire and the motion-resisting device 214 is increased to thereby improve the supporting force for the weight of the carrier device 211. For example, when the two ends of the wire are fixed to two buildings, if the frictional force between the wire and the motion-resisting device 214 is larger, then it is more difficult for skidding to occur between the motion-resisting device 214 and the wire. As such, the present invention can be used in any application that requires movement between two points according to the configuration and position of arrangement of the support device S1, S2 and the motion-resisting device 214.

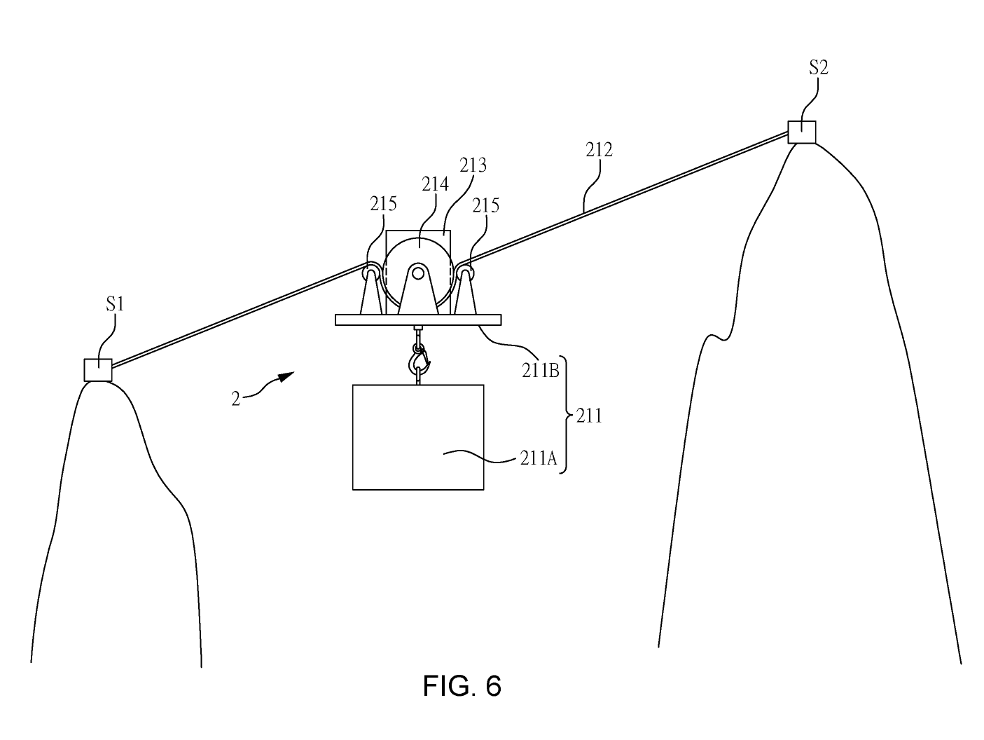

Referring to FIG. 6, which is a schematic view illustrating an example of application of the suspension motion-resisting dynamic system 2 according to the present invention to a cable car, in the application of the present invention to a cable car, since the support devices S1, S2 are mounted on two mountain tops such that the first mountain top and the second mountain top set an inclination angle for the arrangement of a wire. At least one motion-resisting member 215 (similar for the examples of FIGS. 4A, 4B, 4C, 4D, and 5) could be included according to such a configuration to be in contact engagement with the at least one wire for increasing the contact area between the at least one motion-resisting device 214 and the at least one wire to thereby increase the frictional force. As such, the present invention can be used to replace an existing cable car system to allow the carrier device 211 to move between mountain tops by simply increasing the tension of the wire and no cost for building support towers is necessary.

Following the above description, in the examples of FIGS. 4A, 4B, and 5, to prevent interference between the suspension device 212 and the carrier device 211, at least one support member 216 can additionally provided at a proper location to support the suspension device 212. The support member can be arranged in the form of a pulley and this invention provides no limitation. Any element or structure that is effective in supporting and abutting is included in the scope of the support member.

Further, in the example that the present invention is applied to an elevator as shown in FIG. 5, due to vertical movement of the elevator in upward and downward directions, at least one stabilizing member 217 can be additionally included according to the configuration of the elevator to clamp the at least one suspension device 212 for further stabilizing the angle and balance of movement of the carrier device 211. Further, when the carrier device 211 is driven by the motion-resisting device 214, since the arrangement relationship of the support devices S1, S2 may cause the carrier device 211 to tilt, the arrangement of the stabilizing member 217 could help stabilize and clamp the suspension device 212, for further stabilizing the angle of the carrier device 211, maintaining a balanced condition to prevent tilting. Further, in actual installation of an elevator, in case that due to a limited space available in a building, it may not be possible to install a drive device that outputs a large power (and thus has a large size), a weight block may still be possibly installed to increase the loading that the elevator may carry. In addition, in case that the carrier device of the present invention is arranged on an external wall of a building, in addition to functioning as an elevator for elevating and lowering, it may also function as an escape system. Further, one end of the wire is fixed by being buried with the support device S1, S2 in the ground, and the opposite end of the wire is mounted inside or outside the building to fix and stretch the wire. As such, in case of emergency, a user may lower oneself down to the ground from a window by using the present invention.

It is noted that in the embodiments of the present invention, the position, number, and connection relationship of arrangement of the motion-resisting member, the support member, and the stabilizing member are not a novel part of the present invention and thus no specific limitation and disclosure are made herein, provided those components could effectively operate to provide the desired functionality thereof.

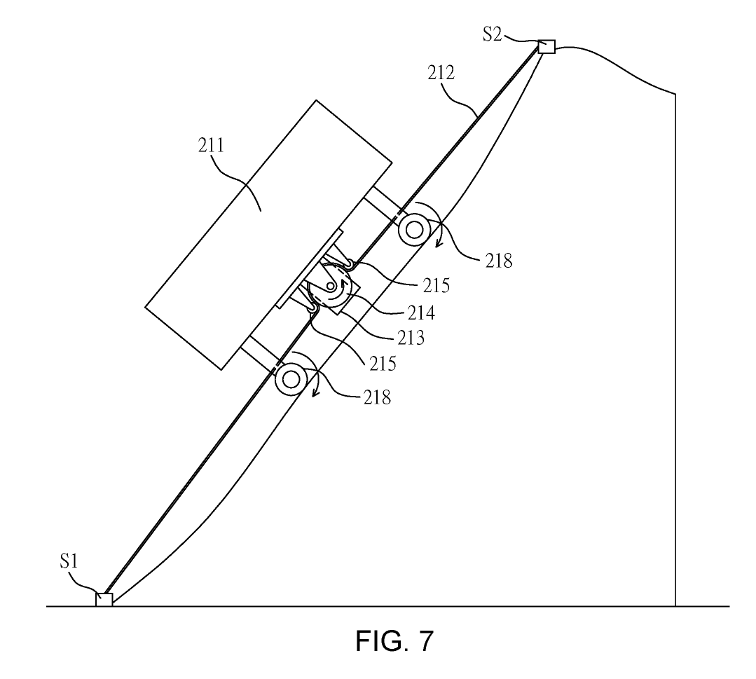

Referring to FIG. 7, which is a schematic view illustrating an example of application of the suspension motion-resisting dynamic system 2 according to the present invention to mountain climbing facilities. The present invention is used as a mountain climbing transportation device and since the support devices S1, S2 are respectively arranged at a mountain foot and a mountain top, the mountain foot and mountain top set an inclination angle of the wire. Thus, in addition to the above described motion-resisting member 215, in the instant embodiment may additionally include, according to the configuration, at least one subordinate dynamic device 218 that is set in contact with the ground in order to increase the frictional force and thus increase a supporting force to the weight of the carrier device 211. As such, the present invention may be used to replace existing mountain climbing facilities to allow the carrier device 211 to move between mountain top and the mountain foot by only increasing the tension of the wire so that the cost of building mountain climbing facilities can be greatly reduced. In addition, it is noted that in the instant embodiment, the motion-resisting device 214 is scrambling along the wire, while the subordinate dynamic device 218 in advancing along with friction thereof with the ground surface so that the directions of rotation of the two are opposite.

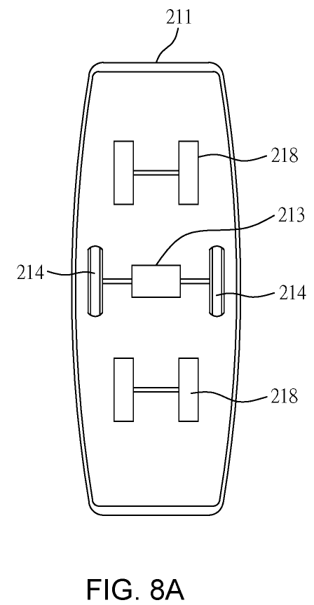

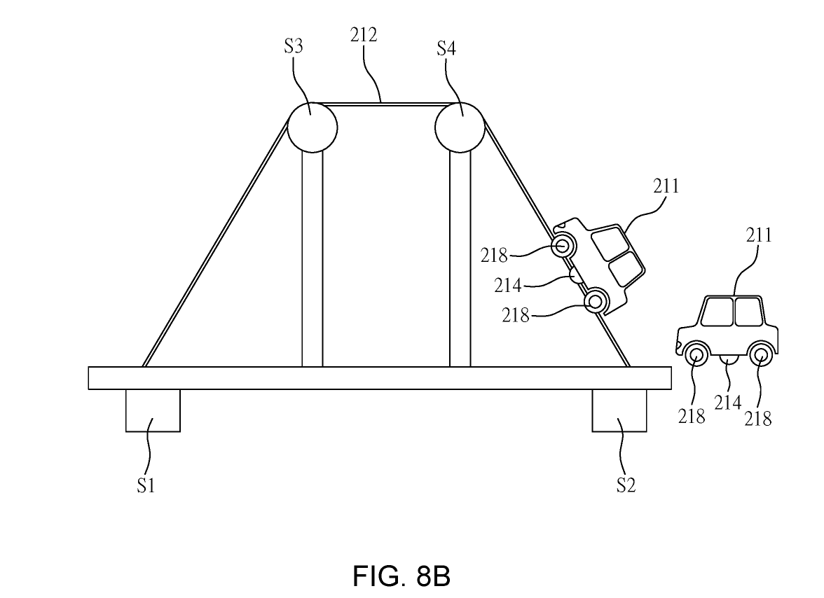

Referring to FIGS. 8A and 8B, which are respectively a bottom view and a side elevational view illustrating an application of the suspension motion-resisting dynamic system 2 according to the present invention to an overpass structure. In the application of the present invention to an overpass structure, since the support devices S1, S2 are installed under ground, the instant embodiments may be made to include, according to the configuration, at least one support device S3, 84 for supporting the suspension device 212. In an actual application, the carrier device 211 comprises a transportation device that is capable of carrying, such as an automobile. The drive device comprises an existing engine of the automobile. The subordinate dynamic device 218 comprises existing wheels of the automobile. The motion-resisting device 214 is arranged on the bottom of the automobile, at two sides of the wheels. The suspension device 212 comprises two wires. As such, when the automobile travels from a regular road into the suspension motion-resisting dynamic system 2, the wheels that are originally in contact with the ground are converted into the motion-resisting device 214 in contact engagement with the wire and driving is switched to the drive device 213 of the suspension motion-resisting dynamic system 2 driving the motion-resisting device 214 to advance along the wire. It is noted that an element, such as a pulley, may be arranged at the site where the support device S3, S4 is set in contact with the wire so that the wire is raised to project beyond a surface of the support device S3, S4 to prevent interference of the support device S3, S4 with the motion-resisting device 214 at a curving portion. As such, the present invention may be used to replace existing mountain climbing facilities to allow the carrier device 211 to move across an overpass structure by only increasing the tension of the wire so that cost of building an overpass structure can be greatly reduced.

In summary, the present invention provides a suspension motion-resisting dynamic system and a suspension active dynamic carrier module, and assembly processes of the two, which allow for completion of installation in a fast, save, and stable fashion in a manner of saving time, saving effort, saving manufacturing cost, saving installation step, and saving space occupied to suit for various needs of users and can be used in various applications, including escape, cable car, elevation, recreation, and carrying.

What is claimed is:

1. A suspension motion-resisting dynamic system, comprising:
at least two support devices; and
at least one hoisting drive module, which comprises:
at least one suspension device, which has two terminal ends and is fixed and stretched by the at least two support devices;
at least one motion-resisting device, which is set in contact engagement with the at least one suspension device; and
at least one drive device, which is coupled to the at least one motion-resisting device to drive the at least one motion-resisting device so as to cause the at least one motion-resisting device to move along the at least one suspension device.

2. The suspension motion-resisting dynamic system according to claim 1, wherein the at least one suspension device comprises at least one wire.

3. The suspension motion-resisting dynamic system according to claim 2, further comprising at least one motion-resisting member in contact engagement with the at least one wire to increase a contact area between the at least one motion-resisting device and the at least one wire.

4. The suspension motion-resisting dynamic system according to claim 1, wherein the at least two support devices are arranged on at least one ground surface, on at least one building, on at least one support post, or on at least one mountain top.

5. The suspension motion-resisting dynamic system according to claim 1, wherein the at least one hoisting drive module further comprises at least one carrier device, the at least one drive device and the at least one motion-resisting device being arranged on the at least one carrier device.

6. A suspension active dynamic carrier module, comprising:
at least one suspension carrier drive module, which comprises:
at least one suspension device, which is connected to the at least one support device;
at least one carrier device; and
at least one drive device, which is arranged on the at least one carrier device and is connected to the at least one suspension device to generate a power for causing the at least one carrier device to move along the at least one suspension device.

7. The suspension active dynamic carrier module according to claim 6, further comprising at least one rail module, which is arranged to correspond, in position, to the at least one carrier device so as to have the at least one carrier device to move by means of the at least one rail module.

8. The suspension active dynamic carrier module according to claim 7, wherein the at least one rail module comprises one of a foldable rail module, an extendible rail module, a cascade rail module, and a curved rail module.

9. The suspension active dynamic carrier module according to claim 7, wherein the at least one support device comprises a structured arranged on at least one support frame, at least one ground surface, at least one building, at least one support post, or at least one mountain top and/or a fixture surface.

10. The suspension active dynamic carrier module according to claim 7, wherein the at least one rail module comprises at least N rails, which are arranged on a fixture surface, wherein N is a positive integer greater than 1.

11. The suspension active dynamic carrier module according to claim 10, further comprising at least N fixing members, which are respectively connected to the at least N rails.

12. The suspension active dynamic carrier module according to claim 11, wherein the at least N rails each have a first end an a second end that are each provided with at least one connection member.

13. The suspension active dynamic carrier module according to claim 12, further comprising a correction device, which is connected to the at least N rails to correct a position of the at least N rails.

14. The suspension active dynamic carrier module according to claim 13, further comprising at least one hoisting device, which hoists the at least N rails for connection with each other with the at least one connection member.
